(19) United States
(12) Patent Application Publication
(10) Pub. No.: US 2011/0035958 A1
(43) Pub. Date: Feb. 17, 2011

(54) DEVICE AND PROCESS FOR DRYING MOVING WEBS OF MATERIAL

(76) Inventors: Klaus Gissing, Judendorf-Strassengel (AT); Rodney Smith, Point Claire (CA)

Correspondence Address: ALIX YALE & RISTAS LLP, 750 MAIN STREET, SUITE 1400, HARTFORD, CT, 06103, US

(21) Appl. No.: 12/736,260

(22) PCT Filed: Mar. 13, 2009
(86) PCT No.: PCT/AT2009/000103

§ 371 Date: Sep. 24, 2010

(30) Foreign Application Priority Data
Mar. 26, 2008 (AT) A 472/2008

(51) Int. Cl. F26B 9/00

(52) U.S. Cl. 34/427; 34/620

(57) ABSTRACT

A drying device for moving webs of material has at least two serial drying groups each having a plurality of heatable drying cylinders. The drying cylinders of at least one first drying group are steam-heated in a first heat circuit. The drying cylinders of at least one second drying group have supply piping for a combustible energy source and discharge piping for waste heat originating from the combustion. A first heat exchanger is provided that couples the first heat circuit for the steam-heated drying cylinders to the discharge piping for the waste heat from the drying cylinders of the second drying group.

The invention relates to a drying device for moving webs of material, especially webs of paper, cardboard or fibrous material, comprising at least two subsequent drying groups each having a plurality of heatable drying cylinders, according to the preamble of Claim 1. The invention also relates to a process for drying moving webs of material, especially webs of paper, cardboard or fibrous material, comprising at least two subsequent drying groups each having a plurality of heatable drying cylinders, according to the preamble of Claim 9.

Drying devices of this kind exist in many embodiments and use drying cylinders of different designs. Steam-heated drying cylinders are known, for example, or also fuel-heated drying cylinders. Steam-heated drying cylinders are fed steam that is generated either in an external boiler or can be taken from other sections of the plant. Fuel-heated drying cylinders are fed a combustible energy source in the form of a liquid or a gas, particularly natural gas, but other energy sources, such as oil, biogas, kerosene, diesel or gasoline, are also conceivable. With fuel-heated drying cylinders, higher evaporation rates are generally obtained than with steam-heated drying cylinders. As it is also an advantage to have different evaporation rates sometimes as drying of webs of material progresses, depending on the moisture content of the web of material, different types of drying cylinder are mostly used in a drying device of the generic kind, for example a succession of steam-heated drying cylinders followed by a succession of gas-heated drying cylinders. These successions of drying cylinders, each of which function in the same way, are referred to as drying groups.

Webs of material are dried with the aid of drying cylinders by the web of material being in direct contact with the cylinder surface. This form of drying is thus referred to as contact drying. The drying cylinders used here can be arranged in one row or two, with deflection rolls, preferably deflection suction rolls, being provided if the drying cylinders are arranged in one row. Here the web of material runs in a meandering path over the cylinders and the deflection rolls. Particularly at the beginning of the drying device, where the web of material still has a relatively high moisture content and thus has low tearing strength, a wire fabric can be provided that runs round the drying cylinder and the deflection rolls together with the web of material. The web of material is thus supported on the wire fabric, coming into direct contact with the cylinder surface at the drying cylinders, but rests on the outside of the wire, fabric at the deflection rolls and is therefore no longer in direct contact with the roll surface. The web of material thus only ever rests on the drying cylinders on one of its two sides.

When the web of material has dried sufficiently, the evaporation rate can be increased on the one hand, and on the other hand the material web has sufficient tearing strength to pass through a drying group without being supported on a wire fabric or similar. In these end sections of the drying device, one drying group can be provided, for example, in which gas-heated drying cylinders are arranged in two rows. The web of material runs alternately around a drying cylinder from the top row and the bottom row, with both of its surfaces coming alternately into direct contact with the surface of a drying cylinder.

Here, drying can be aided by additional drying processes using infrared or hot air. A hot air current can be directed at the surface of the web of material, for example, and either flows through it if the material has the appropriate permeability or reflects off the web of material, taking moisture with it. In these cases where drying is performed with the aid of a hot air current, the process is also referred to as convection drying. As a rule, drying hoods with heat supply and heat discharge piping to carry the hot air current are arranged around the circumference of the drying cylinder.

As already mentioned, the web of material is very delicate in the initial stages of the drying device due to the web's high moisture content. Steam-heated drying cylinders with a wire fabric support are generally used in these areas because their evaporation rate is relatively low and the web of material can be dried gently. In order to dry the web of material completely, however, a relatively large number of steam-heated drying cylinders are needed, which increases the space requirement, building and maintenance costs.

In contrast, gas-heated drying cylinders generate relatively high evaporation rates. A drying line consisting only of gas-heated drying cylinders would, however, have unjustifiably poor energy efficiency because high evaporation rates are not needed over the entire drying line. In particular, gas-heated drying cylinders cannot be used in the initial stages of a drying device, where the web of material is still very damp and delicate and high evaporation rates must be avoided.

The problem thus addressed by the present invention is to avoid these disadvantages and provide a drying device that permits different evaporation rates in different areas, but is also more energy-efficient than conventional drying devices. Furthermore, the drying device according to the invention should enable a simpler plant arrangement.

These goals are achieved by the characteristic features described in Claims 1 and 9, respectively. Claim 1 refers to a drying device for moving webs of material, particularly paper, cardboard or fibrous material, with at least two subsequent drying groups each having a plurality of heatable drying cylinders, where the invention provides for the drying cylinders of at least one first drying group being steam-heated drying cylinders, where a first heat circuit is provided for the steam, and the drying cylinders of at least one second drying group having supply piping for a combustible energy source and discharge piping for the waste heat originating from combustion of the energy source, where a first heat exchanger is provided that couples the first heat circuit for the steam from the steam-heated drying cylinders of the at least one first drying group to the discharge piping for the waste heat from the drying cylinders of the at least one second drying group.

The device according to the invention thus combines fuel-heated drying to cylinders on the one hand, with which high evaporation rates can be achieved, with steam-heated drying cylinders, which have comparatively low evaporation rates. The latter are used ideally in the initial stages of the drying device. The invention also provides for the steam required by the steam-heated drying cylinder being carried in a heat circuit to which the waste air from the at least one second drying group is fed via a heat exchanger. Thus, in an ideal arrangement no separate device is needed to generate steam with the aid of a boiler house or similar, with the that the plant arrangement is simplified and the overall cost of the plant lowered. In addition, heat transfer losses can be reduced because the transport routes for the steam from the first drying group can be kept short. Since the waste heat from heating of the second drying group can be used in addition to heat the first drying group, the energy efficiency of the entire plant is increased. In particular, the proportion of primary energy required is reduced, as is the level of waste heat from the process. Finally, the arrangement according to the invention enables targeted selection of different evaporation rates in different sections of the drying device.

In an advantageous embodiment of the invention, the first heat exchanger can be a gas-liquid heat exchanger because the transfer of heat from the gaseous waste heat to the first heat circuit for evaporation of the liquid phase takes place under favorable thermodynamic conditions.

According to an advantageous further development of the invention, further waste heat is recovered for additional air drying after passing through the first heat exchanger. For this purpose the invention provides for a drying hood with heat supply and heat discharge piping arranged around the circumference of at least one drying cylinder of the at least one second drying group, where the heat supply and heat discharge piping form a second heat circuit that has a second heat exchanger connected to the first heat exchanger in order to supply waste heat from the first heat exchanger to it. The second heat exchanger is advantageously an air-air heat exchanger.

Fresh air is required to combust the energy source when heating the drying cylinder of the at least one second drying group. In order to keep energy losses low, waste heat from combustion is taken to heat this fresh air beforehand. A further advantageous embodiment of the invention thus provides for the drying cylinder of the at least one second drying group having fresh air supply piping with a third heat exchanger, where the third heat exchanger is connected to the second heat exchanger to carry off the waste heat from the second heat exchanger. The third heat exchanger is advantageously an air-air heat exchanger.

According to a further advantageous further development of the invention, a third heat circuit can ultimately be provided that is linked on the one hand to the first heat circuit via a steam separator, and on the other hand to the fresh air supply piping of the at least one second drying group via a fourth heat exchanger. There is no full condensation when running over the steam-heated drying cylinder, and some steam always remains and is removed subsequently in the steam separator. This steam is used to heat fresh air in the fourth heat exchanger. In the fourth heat exchanger the steam condenses almost entirely and can be added to the condensate from the steam separator. The steam that has now fully condensed can be fed to the first heat exchanger in the first heat circuit.

The dry fresh air that has been heated can be put to various uses. In a further advantageous embodiment, for example, the first and/or second drying group can be at least partly surrounded by a steam hood that is connected to the waste air piping for the heated fresh air from the fourth heat exchanger. When the web of material is being dried, large quantities of damp air are generated that collect inside the steam hood and can be pushed out of the steam hood with the aid of dry, heated fresh air.

Finally, a suitable process for drying moving webs of material, particularly paper, cardboard or fibrous material, with at least two subsequent drying groups each having a plurality of heatable drying cylinders is also suggested. The invention provides for the drying cylinders of at least one first drying group being heated with steam, which is carried in a first heat circuit, and the drying cylinder of at least one second drying group being heated with a combustible energy source, where waste heat from combustion of the energy source from the at least one second drying group is fed to the first heat circuit. In a further embodiment of the process, waste heat from combustion of the energy source from the at least one second drying group is fed to an air current in a second heat circuit for convection drying of the moving web of material.

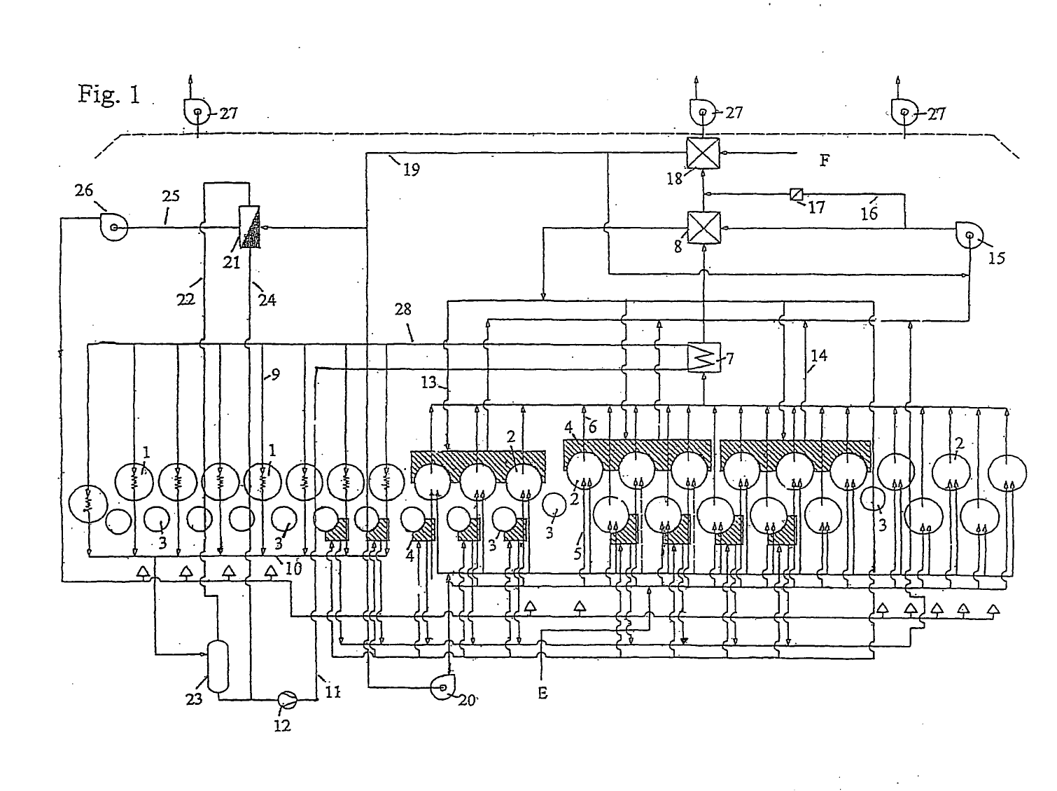

In the following, the invention is described in more detail on the basis of an example with the aid of the enclosed FIG. 1. Here, FIG. 1 shows a diagram of an embodiment of the drying device according to the invention.

The drying device according to FIG. 1 has a first drying group formed by steam-heated drying cylinders 1 and a second drying group formed by gas-heated drying cylinders 2. According to the embodiment in FIG. 1, the steam-heated drying cylinders 1 are arranged in one row, with deflection rolls 3 being provided under the steam-heated cylinders 1, however the drying cylinders 1 could also be arranged in two rows. The damp web of material is fed in from the left-hand side in FIG. 1 and runs around the steam-heated drying cylinders 1 and the deflection rolls 3 in a meandering path, being supported at the same time on a wire fabric (not shown in FIG. 1.). The web of material is thus only dried through its underside in the first drying group. The steam-heated drying cylinders 1 can also be fitted with blow nozzles here to clean the cylinder surfaces and which are also referred to as air-blow doctors. The deflection rolls 3 are preferably deflection suction rolls with a perforated surface that can thus hold the web of material and the wire fabric, respectively, by suction. Furthermore, additional air jets (not shown in FIG. 1) can be provided to stabilize the web or to make it easier to thread in the web of material.

A second drying group is formed by gas-heated drying cylinders 2 with drying hoods 4, at least in places around their circumference. According to the embodiment in FIG. 1, there is also an area provided in the middle section formed on the one hand by gas-heated drying cylinders 2 arranged in a single row, as well as by deflection rolls 3, which also have drying hoods 4 assigned to them. Between this middle section and the first as well as the second drying group, web transfer units (not shown in FIG. 1) may also be provided to improve transfer and make it easier to thread in the web of material between the individual sections.

The gas-heated drying cylinders 2 in the second drying group each have supply piping 5 for a combustible energy source E, as well as discharge piping 6 for the waste heat from combustion of the energy source E. Here, the waste heat is supplied through the discharge piping 6 of a first heat exchanger 7, which is a gas-liquid heat exchanger. In the first heat exchanger 7, some of the waste heat is passed on to a first heat circuit, where the condensed steam is transferred to the gaseous phase. The first heat circuit consists of a supply line 28 and distribution pipes 9 in which steam is fed to the steam-heated drying cylinders 1 in the first drying group. Furthermore, the first heat circuit comprises collecting pipes 10 in which the condensate from the steam-heated drying cylinders 1 is collected, where some of the steam, referred to as blow-through steam, remains in the condensate. A discharge line 11 from the first heat circuit finally carries the liquid phase to the first heat exchanger 7 again. A pressure reducing valve (not shown in FIG. 1) can be provided optionally in the supply line 28 to the benefit of the steam phase, as well as a condenser 12 in the discharge line 11 to the benefit of the liquid phase.

The first heat exchanger 7 is connected via piping to a second heat exchanger 8 in which more of the waste heat is passed on to a second heat circuit. The second heat circuit consists of heat supply piping 13 that supplies heated drying air to the drying hoods 4, as well as heat discharge piping 14 that carries off the damp drying air from the drying hoods 4. A first blower 15 can be provided in order to generate circulation in the second heat circuit. To discharge damp drying air from the second heat circuit it is useful to have bridging piping 16 with a controller 17.

The second heat exchanger 8 is connected additionally by piping to a third heat exchanger 18, where more of the waste heat is transferred to fresh air F in order to heat it to temperatures of 50 to 60° C. The heated fresh air is fed through fresh air piping 19 and a blower 20 to the gas-heated drying cylinders 2 in the second drying group. The fresh air piping 19 is further connected to a fourth heat exchanger 21 in which the fresh air heated with the aid of a third heat exchanger 18 is heated further to temperatures of approximately 100° C. for example. The heat required for this is taken from a third heat circuit which comprises steam separator piping 22 on the one hand, which connects the fourth heat exchanger 21 to a steam separator 23 and feeds the steam removed from the first heat circuit to the fourth heat exchanger 21, and on the other hand comprises condensate piping 24 that mixes the condensate from the fourth heat exchanger 21 into the condensate from the first heat circuit.

The discharge piping 25 carries the fresh air heated to approximately 100° C. via a blower 26 to a steam hood that at least partly surrounds the first and/or second drying group. The heated and comparatively dry fresh air can be used, as already mentioned, to discharge the moisture collecting in the course of drying of the web of material from the steam hood for example, but it could also be used in the above mentioned air-blow doctors, for example, to clean the cylinder surfaces of the steam-heated drying cylinders 1, or at the air jets for web stabilizing. Additional blowers 27 are used to remove exhaust air from the entire drying process.

With the aid of the invention, a drying device is thus provided that enables different evaporation rates from one section to another, but is also more energy-efficient than conventional drying devices. The primary energy from combustible energy sources E is only used in drying where high evaporation rates are possible and necessary, but on the other hand sufficient energy is recovered from the waste heat as a result of combustion of the energy source E to be able to use heat in the form of steam or hot air in places where lower evaporation rates are required. Furthermore, the drying device according to the invention permits a simpler plant arrangement because no external steam generating equipment, for example, is needed for the steam-heated drying cylinder 1.

1.-10. (canceled)

11. A drying device for moving webs of material comprising at least two drying groups each having a plurality of heatable drying cylinders, wherein
the drying cylinders of at least one first drying group are steam-heated drying cylinders;
a first heat circuit is provided for the steam;
the drying cylinders of at least one second drying group have supply piping for a combustible energy source and discharge piping for waste heat originating from combustion of the energy source; and
a first heat exchanger is provided that couples the first heat circuit for the steam from the steam-heated drying cylinders of the at least one first drying group to the discharge piping for the waste heat from the drying cylinders of the at least one second drying group.

12. Drying device according to claim 11, wherein the first heat exchanger is a gas-liquid heat exchanger.

13. Drying device according to claim 11, wherein
a drying hood with heat supply and heat discharge piping are arranged around the circumference of at least one drying cylinder of the at least one second drying group; and
the heat supply and heat discharge piping form a second heat circuit that has a second heat exchanger connected to the first heat exchanger in order to receive waste heat from the first heat exchanger.

14. Drying device according to claim 13, wherein the second heat exchanger is an air-air heat exchanger.

15. Drying device according to claim 13, wherein the drying cylinder of the at least one second drying group has fresh air supply piping with a third heat exchanger, where the third heat exchanger is connected to the second heat exchanger to carry off the waste heat from the second heat exchanger.

16. Drying device according to claim 15, wherein the third heat exchanger is an air-air heat exchanger.

17. Drying device according to claim 15, wherein a third heat circuit is linked to the first heat circuit by a steam separator, and to the fresh air supply piping of the at least one second drying group by a fourth heat exchanger.

18. Drying device according to claim 17, wherein at least one of the first and second drying group is at least partly surrounded by a steam hood that is connected to waste air piping for the heated fresh air from the fourth heat exchanger.

19. Drying device according to claim 12, wherein
a drying hood with heat supply and heat discharge piping are arranged around the circumference of at least one drying cylinder of the at least one second drying group; and
the heat supply and heat discharge piping form a second heat circuit that has a second heat exchanger connected to the first heat exchanger in order to receive waste heat from the first heat exchanger.

20. Drying device according to claim 19, wherein the second heat exchanger is an air-air heat exchanger.

21. Drying device according to claim 19, wherein the drying cylinder of the at least one second drying group has fresh air supply piping with a third heat exchanger, where the third heat exchanger is connected to the second heat exchanger to carry off the waste heat from the second heat exchanger.

22. Drying device according to claim 20, wherein the third heat exchanger is an air-air heat exchanger.

23. Drying device according to claim 20, wherein a third heat circuit is linked to the first heat circuit by a steam separator, and to the fresh air supply piping of the at least one second drying group by a fourth heat exchanger.

24. Drying device according to claim 23, wherein at least one of the first and second drying group is at least partly surrounded by a steam hood that is connected to waste air piping for the heated fresh air from the fourth heat exchanger.

25. Drying device according to claim 19, wherein
a drying hood with heat supply and heat discharge piping are arranged around the circumference of at least one drying cylinder of the at least one second drying group;
the heat supply and heat discharge piping form a second heat circuit that has a second heat exchanger connected to the first heat exchanger in order to receive ly waste heat from the first heat exchanger;
the second heat exchanger is an air-air heat exchanger;
the drying cylinder of the at least one second drying group has fresh air supply piping with a third heat exchanger, where the third heat exchanger is connected to the second heat exchanger to carry off the waste heat from the second heat exchange;
the third heat exchanger is an air-air heat exchanger;
a third heat circuit is linked to the first heat circuit by a steam separator, and to the fresh air supply piping of the at least one second drying group by a fourth heat exchanger; and
at least one of the first and second drying group is at least partly surrounded by a steam hood that is connected to waste air piping for the heated fresh air from the fourth heat exchanger.

26. Process for drying moving webs of material with at least two drying groups each having a plurality of heatable drying cylinders, comprising:
heating the drying cylinders of at least one first drying group with steam carried in a first heat circuit;
heating the drying cylinders of at least one second drying group with a combustible energy source that produces waste heat from the second drying group;
delivering at least some said waste heat to the first heat circuit.

27. Process according to claim 26, wherein at least some of said waste heat is delivered to an air current in a second heat circuit for convection drying of the moving web of material.
